(19) United States
(12) Patent Application Publication
(10) Pub. No.: US 2025/0149759 A1
(43) Pub. Date: May 8, 2025

(54) TEMPERATURE ACQUISITION ASSEMBLY FOR BATTERY CELL AND BATTERY MODULE

(71) Applicant: EVE ENERGY CO., LTD., Huizhou, Guangdong (CN)

(72) Inventor: Shuai YANG, Huizhou, Guangdong (CN)

(73) Assignee: EVE ENERGY CO., LTD., Huizhou, Guangdong (CN)

(21) Appl. No.: 18/833,886

(22) PCT Filed: May 12, 2023
(86) PCT No.: PCT/CN2023/093833

§ 371 Date: Jul. 27, 2024

(30) Foreign Application Priority Data
Mar. 27, 2023 (CN) 202320632896.X

(51) Int. Cl. H01M 50/569; H01M 10/613; H01M 10/643; H01M 10/6556; H01M 50/213; H01M 50/244; H01M 50/519

(52) U.S. Cl. CPC H01M 50/569; H01M 10/613; H01M 10/643; H01M 10/6556; H01M 50/244; H01M 50/519; H01M 50/213

(57) ABSTRACT

A temperature acquisition assembly for battery cells and a battery module are provided. The temperature acquisition assembly for battery cells includes a support and temperature sensor(s). The support includes side plates and a bracket body that are connected at an included angle. The bracket body is configured to support busbars. The side plates are located at sides of the battery cells. A side surface of each side plate which is adjacent to the battery cells is provided with accommodation groove(s). Openings of the accommodation groove(s) face towards the battery cells, and the temperature sensor(s) are provided in the accommodation groove(s).

### CROSS-REFERENCE TO RELATED APPLICATIONS

This application claims priority to and the benefit of Chinese Patent Application No. 202320632896.X, filed on Mar. 27, 2023, the disclosure of which is incorporated herein by reference in its entirety.

### TECHNICAL FIELD

The present application relates to the field of energy storage devices, for example, to a temperature acquisition assembly for battery cells and a battery module.

### BACKGROUND

In the related art, as for a conventional large-cylinder power battery, the temperature of a battery cell thereof is acquired by placing a conventional patch-type temperature sensor or a water drop head encapsulation type temperature sensor on an upper surface of a negative electrode of the battery cell. However, this acquisition manner limits the position of the temperature sensor, which is only applicable to a battery module in which a liquid-cooled plate is provided on a bottom of the battery cell and on a side of the battery cell, and is not applicable to a battery module in which a liquid-cooled plate is provided on a top of the battery cell.

### SUMMARY

According to the present application, it is provided a temperature acquisition assembly for battery cells and a battery module, which can realize that the position for acquiring the temperature of a battery cell is not limited by a position of a liquid cooling plate.

In a first aspect, according to an embodiment, it is provided a temperature acquisition assembly for battery cells, including a support and one or more temperature sensors, in which the support includes side plates and a bracket body that are connected at an included angle, the bracket body is configured to support busbars, the side plates are located at sides of the battery cells, a side surface of each of the side plates which is adjacent to the battery cells is provided with one or more accommodation grooves, openings of the one or more accommodation grooves face towards the battery cells, and the one or more temperature sensors are provided in the one or more accommodation grooves.

In an embodiment, a side surface of the side plate which faces toward the battery cells is protrudingly provided with one or more bosses, and the one or more accommodation grooves are provided in the one or more bosses.

In an embodiment, each of the one or more bosses has an arc surface, the arc surface is fitted with a side surface of a corresponding one of the battery cells, and the accommodation groove is provided on the arc surface.

In an embodiment, each of the one or more bosses is arranged to locate in a free region between adjacent two of the battery cells, when shapes of the battery cells are cylinder-shaped.

In an embodiment, each of the one or more accommodation grooves is filled with a thermally conductive adhesive layer, and a corresponding one of the one or more temperature sensors is located within the thermally conductive adhesive layer.

In an embodiment, the temperature acquisition assembly for the battery cells includes connection wires, wherein a circuit board is provided at one side of the side plate which is away from the battery cells, a connection hole is provided in each of the one or more accommodation grooves, a first end of each of the connection wires is connected to a corresponding one of the one or more temperature sensors, and a second end of the connection wire is connected to the circuit board by passing through the connection hole.

In an embodiment, in a direction of a central axis of each of the battery cells, an end portion of the accommodation groove which is adjacent to an end of the bracket body is provided with the connection hole, and the connection hole penetrates through the support.

In an embodiment, enclosed walls are provided on the circuit board, each of the enclosed walls is enclosed to form a connection slot, a side of the enclosed wall is provided with an opening, and the connection wire is sequentially passed through the connection hole and the opening, and inserted into the connection slot to be connected to the circuit board.

In an embodiment, the connection slot is filled with a connection glue.

In an embodiment, the temperature acquisition assembly for the battery cells includes voltage acquisition sheets, wherein the voltage acquisition sheets each includes a first sheet and a second sheet disposed at an included angle, the first sheet is connected to a corresponding one of the busbars, and the second sheet is connected to the circuit board.

In an embodiment, each of the one or more temperature sensors is snapped into a corresponding one of the one or more accommodation grooves, and a width of an opening of the accommodation groove is smaller than a size of the temperature sensor.

In an embodiment, the side plates include two side plates, the two side plates are respectively located on two sides of the bracket body, and the two side plates are each provided with the one or more accommodation grooves.

In an embodiment, each of the side plates is provided with a plurality of the one or more accommodation grooves, the plurality of accommodation grooves are provided at intervals along an arrangement direction of the battery cells, and each of the accommodation grooves is provided with a corresponding one of the one or more temperature sensors.

In an embodiment, the bracket body includes a first side surface and a second side surface that are oppositely disposed, the first side surface is recessedly provided with first positioning grooves, end portions of the battery cells are inserted into the first positioning grooves, the second side surface is recessedly with second positioning grooves, and the second positioning grooves are provided with the busbars.

In a second aspect, according to the present application, it is provided a battery module including battery cells and the temperature acquisition assembly for the battery cells mentioned above, in which the one or more temperature sensor of the temperature acquisition assembly for the battery cells are configured to acquire temperatures of the battery cells.

Advantageous effects of the present application are as follows.

By providing the side plates, the mounting position for the temperature sensor can be supplied. The side plates are provided at the sides of the battery cells, the position of the temperature sensor can be flexibly adjusted according to the size of the battery cells, and the position of the temperature sensor is not limited by the position of the liquid cooling plate.

### BRIEF DESCRIPTION OF THE DRAWINGS

FIG. 1 is a schematic diagram of a battery cell temperature acquisition assembly according to an embodiment of the present application.

FIG. 2 is an enlarged schematic view at detail A of FIG. 1.

FIG. 3 is a schematic diagram of a battery cell, a support and a temperature sensor according an embodiment of the present application.

FIG. 4 is a schematic diagram of a battery module according to an embodiment of the present application.

FIG. 5 is an enlarged schematic view at detail B of FIG. 4.

In the figure:

100, battery cell;

1, support; 11, bracket body; 111, first positioning groove; 112, second positioning groove; 12, side plate; 121, boss; 1211, arc surface; 1212, accommodation groove; 2, temperature sensor; 3, busbar; 4, connection wire; 5, circuit board; 6, voltage acquisition sheet; 61, first sheet; 62, second sheet; 7, enclosed wall; and 71, connection slot.

### DETAILED DESCRIPTION

In the description of the present application, unless otherwise expressly defined and defined, the terms “connected”, “connection”, “fixed” are to be understood in a broad sense, for example, which may be interpreted as a fixed connection, as a detachable connection, or as a whole; may be interpreted as a mechanical connection or an electrical connection; may be interpreted as a direct connection or indirect connection by means of an intermediate medium; or may be interpreted as an internal communication of the two elements or interaction of the two elements. The specific meaning of the above terms in the present application can be understood in a specific way to those of ordinary skill in the art.

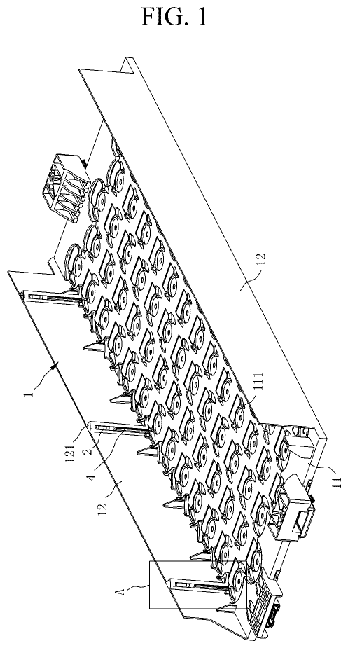

As shown in FIGS. 1 to 3, it is provided a temperature acquisition assembly for battery cells including a support 1 and temperature sensor(s) 2. The support 1 includes side plates 12 and a bracket body 11 perpendicularly connected. The bracket body 11 is used to support busbars 3. The side plate 12 is located at a side of battery cells 100. A side surface of the side plate 12 which is adjacent to the battery cells 100 is provided with accommodation groove(s) 1212. An opening of the accommodation groove 1212 faces towards the battery cells 100, and the temperature sensor 2 is provided in the accommodation groove 1212. By providing the side plates 12, it is possible to provide a mounting position for the temperature sensor 2. And, the side plates 12 are provided at the side of the battery cells 100, it can flexibly adjust the position of the temperature sensor 2 according to the sizes of the battery cells 100, and thus the position of the temperature sensor 2 is not limited by the position of the liquid-cooled plate.

In an embodiment, a side surface of the side plate 12 which faces towards the battery cells 100 is provided protrudingly with boss(es) 121, and the accommodation groove 1212 is provided in the boss 121. By providing the boss 121, the partial thickness of the side plate 12 can be increased without affecting the overall thickness of the side plate 12, thereby facilitating the formation of the accommodation groove 1212.

In an embodiment, the battery cell 100 is cylindrical in shape, the boss 121 has an arc surface 1211 that fits with the side surface of the battery cell 100, and the accommodation groove 1212 is provided on the arc surface 1211. By providing the arc surface 1211 on the boss 121 and forming the accommodation groove 1212 on the arc surface 1211, the accommodation groove 1212 can be brought closer to the battery cells 100. In this way, the heat emitted from the battery cells 100 can be effectively transferred to the temperature sensor 2, thereby improving the accuracy of temperature detection.

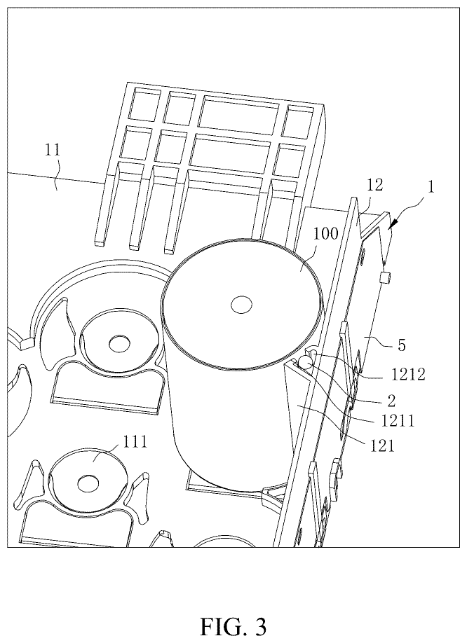

In an embodiment, referring to FIG. 3, the battery cell 100 is a cylindrical battery cell, that is, the battery cell 100 is cylindrical in shape. A free region is provided between two adjacent battery cells 100, and the boss 121 is provided in the free region. By arranging the boss 121 in the free region between the two battery cells 100, not only the temperature sensor 2 can be placed in the space between the two battery cells 100 sufficiently, but also the temperature sensor 2 can be made closer to the battery cell 100, so as to accurately measure the temperature of the battery cell 100.

In an embodiment, the accommodation groove 1212 is filled with a thermally conductive adhesive layer, and the temperature sensor 2 is located within the thermally conductive adhesive layer. When the heat generated by the battery cells 100 is transferred to the temperature sensor 2, a part of the heat is dissipated by the air, thus this part of heat dissipation can be reduced due to the thermally conductive adhesive layer, thereby improving the accuracy of detection by the temperature sensor 2.

In an embodiment, two side plates 12 are provided. Two side plates 12 are respectively located on two sides of the bracket body 11, and two side plates 12 are respectively provided with accommodation grooves 1212. By providing the two side plates 12, the temperature at two sides of the battery module can be detected, respectively, so that the accuracy of detection can be improved.

In an embodiment, each side plate 12 is provided with multiple accommodation grooves 1212. The multiple accommodation grooves 1212 are provided at intervals along the length direction of the side plate 12, and each accommodation groove 1212 is provided with the temperature sensor 2. By arranging the multiple temperature sensors 2, the temperature detection points are increased. So, it is possible to perform the comprehensive temperature detection on the battery module, thereby more accurately judging the heat-generation cases of the battery cells 100 in the battery module.

In an embodiment, a circuit board 5 is provided at a side of the side plate 12 which is away from the battery cells 100, and the accommodation groove 1212 is provided with a connection hole. The temperature acquisition assembly for battery cells includes connection wires 4. A first end of the connection wire 4 is connected to the temperature sensor 2, and a second end of the connection wire 4 is connected to the circuit board 5 by passing through the connection hole. By arranging the circuit board 5 at a side of the side plate 12 which is away from the battery cells 100, the space of the side plate 12 can be fully utilized for fixing the circuit board 5. By fixing the circuit board 5 to the side plate 12, the distance between the circuit board 5 and the temperature sensor 2 can be shortened, and the length of the connection wire 4 can be shortened, thereby simplifying the structure of the temperature acquisition assembly for battery cells. In the present embodiment, the circuit board 5 is a Flexible Printed Circuit (referred briefly to as FPC).

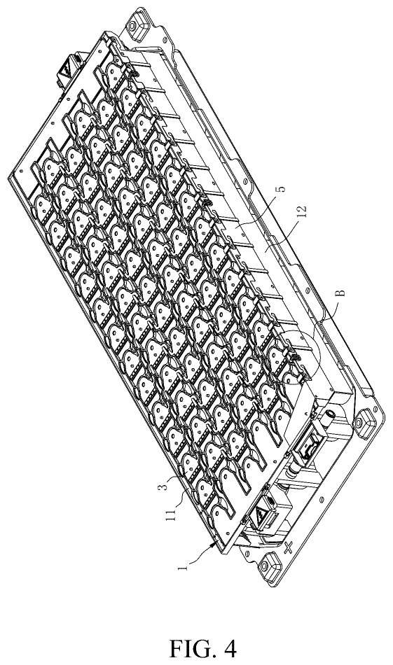

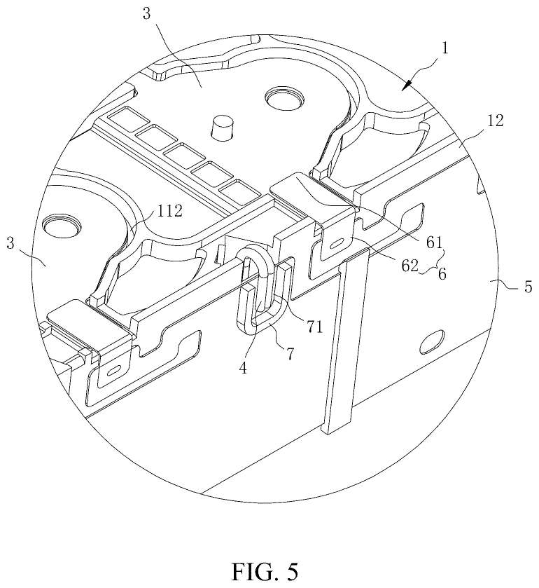

Referring to FIGS. 4 and 5, in the present embodiment, an end portion of the accommodation groove 1212 which is adjacent to an end of the bracket body 11 is provided with a connection hole extending through the bracket body 11, in a direction of a central axis of the battery cell 100. By providing the connection hole at the end portion of the accommodation groove 1212 which is adjacent to the end of the bracket body 11, the wiring of the connection wires 4 can be facilitated, thereby further simplifying the structure of the temperature acquisition assembly for battery cells.

In an embodiment, the circuit board 5 is provided with enclosed walls 7, and each enclosed wall is enclosed with the surface of the circuit board 5 to form a connection slot 71. One side of the enclosed wall 7 is provided with an opening, and the connection wire 4 is sequentially passed through the connection hole and the opening, and inserted into the connection slot 71, so as to be connected to the circuit board 5. By providing the enclosed walls 7 protruding from the surface of the circuit board 5, the connection wires 4 can be shielded, thereby reducing the probability of external collision of the connection wires 4.

In an embodiment, the connection slot 71 is filled with a connection glue. By filling the connecting glue in the connection slot 71, the connecting strength of the connection wire 4 and the circuit board 5 can be improved, and the open circuit between the connection wire 4 and the circuit board 5 can be avoided.

In an embodiment, the temperature acquisition assembly for battery cells includes voltage acquisition sheets 6 each including a first sheet 61 and a second sheet 62 arranged at an included angle. The first sheet 61 is connected to the busbar 3, and the second sheet 62 is connected to the circuit board 5. In the present embodiment, a shape of the voltage collecting sheet 6 is L-shaped, so that the structure of the voltage collecting sheet 6 is adapted to the positions of the bracket body 11 and the circuit board 5.

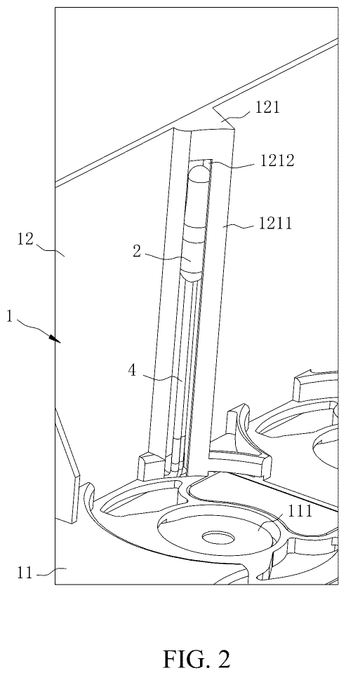

In an embodiment, the temperature sensor 2 is snapped into the accommodation groove 1212, and the width of the opening of the accommodation groove 1212 is smaller than the size of the temperature sensor 2. Since the width of the opening of the accommodation groove 1212 is smaller than the size of the temperature sensor 2, the temperature sensor 2 is snapped into the accommodation groove 1212. So, the temperature sensor 2 can be prevented from being detached from the accommodation groove 1212, and the displacement of the temperature sensor 2 can be prevented. Referring to FIG. 5, an end of the accommodation groove 1212 which is away from the bracket body 11 extends through the boss. Referring to FIG. 2, the end of the accommodation groove 1212 which is away from the bracket body 11 does not extend through the boss. In other embodiments, the connection hole may be provided in the wall of the accommodation groove 1212. The present embodiment is not limited herein, and the position of the connection hole may be provided according to actual needs.

In the present embodiment, a shape of the accommodation groove 1212 is strip shape, and extends in a vertical direction, that is, along the length direction of the battery cell 100. Therefore, the position of the temperature sensor 2 can be adjusted up and down as required to realize temperature acquisition of the battery cell 100.

In an embodiment, the bosses 121, the side plates 12, and the bracket body 11 are of an integral structure. That is, the support 1 is integrally molded, and the support 1 can be manufactured by means of a Computer numerical control (referred briefly to as CNC) or injection molding, so that the assembly process of the battery module can be reduced.

The bracket body 11 has a first side surface and a second side surface which are oppositely disposed. The first side surface is recessedly formed with first positioning grooves 111, and an upper end portion of the battery cell 100 is inserted into the first positioning groove 111. The second side surface is recessedly formed with second positioning grooves 112, and the second positioning groove 112 is provided with the busbar 3. By providing the first positioning grooves 111 and the second positioning grooves 112, positioning and assembling of the busbars 3, the bracket body 11 and the battery cells 100 can be facilitated, thereby improving production efficiency.

The present embodiment also provides a battery module including battery cells 100 and the temperature acquisition assembly for battery cells in any of the above embodiments. The temperature sensors 2 of the temperature acquisition assembly for the battery cells are configured to acquire temperatures of the battery cells 100. Since the position of the temperature sensor 2 are not limited by the position of the liquid cooling plate, the liquid cooling plate of the battery module in this embodiment can be designed as required, and the position of the temperature sensor 2 does not need to dodge the liquid cooling plate. Since the position of the temperature sensor 2 is not limited by the position of the liquid cooling plate, it is suitable for a top liquid cooling structure, a bottom liquid cooling structure, and a side liquid cooling structure of a large cylindrical power battery.

In the descriptions of the present application, it is to be understood that, terms such as “upper”, “lower”, “left”, “right” and the like should be construed to refer to the orientation or position relationship as illustrated in the drawings. These terms are for convenience of description and simplified operation, and do not indicate or imply that the device or element referred to must have a particular orientation, or be constructed and operated in a particular orientation. Thus, these terms shall not be construed as limitation on the present application. In addition, terms such as “first” and “second” are only used for distinguishing in description, and have no special meaning.

Reference throughout this specification to terms “an embodiment”, “an example”, and the like means that a particular feature, structure, material, or characteristic described in connection with the embodiment or example is included in at least an embodiment or example of the present application. In this specification, the appearances of the phrases are not necessarily referring to the same embodiment or example.

1. A temperature acquisition assembly for battery cells comprising a support and one or more temperature sensors, wherein the support comprises side plates and a bracket body that are connected at an included angle, the bracket body is configured to support busbars, the side plates are located at sides of the battery cells, a side surface of each of the side plates which is adjacent to the battery cells is provided with one or more accommodation grooves, openings of the one or more accommodation grooves face towards the battery cells, and the one or more temperature sensors are provided in the one or more accommodation grooves.

2. The temperature acquisition assembly for the battery cells according to claim 1, wherein the side surface of the side plate which is adjacent to the battery cells is protrudingly provided with one or more bosses, and the one or more accommodation grooves are provided in the one or more bosses.

3. The temperature acquisition assembly for the battery cells according to claim 2, wherein each of the one or more bosses has an arc surface, the arc surface is fitted with a side surface of a corresponding one of the battery cells, and the accommodation groove is provided on the arc surface.

4. The temperature acquisition assembly for the battery cells according to claim 2, wherein each of the one or more bosses is arranged to locate in a free region between adjacent two of the battery cells, when shapes of the battery cells are cylinder-shaped.

5. The temperature acquisition assembly for the battery cells according to claim 1, wherein each of the one or more accommodation grooves is filled with a thermally conductive adhesive layer, and a corresponding one of the one or more temperature sensors is located within the thermally conductive adhesive layer.

6. The temperature acquisition assembly for the battery cells according to claim 1, comprising connection wires, wherein a circuit board is provided at one side of the side plate which is away from the battery cells, a connection hole is provided in each of the one or more accommodation grooves, a first end of each of the connection wires is connected to a corresponding one of the one or more temperature sensors, and a second end of the connection wire is connected to the circuit board by passing through the connection hole.

7. The temperature acquisition assembly for the battery cells according to claim 6, wherein, in a direction of a central axis of each of the battery cells, an end portion of the accommodation groove which is adjacent to an end of the bracket body is provided with the connection hole, and the connection hole penetrates through the support.

8. The temperature acquisition assembly for the battery cells according to claim 7, wherein enclosed walls are provided on the circuit board, each of the enclosed walls is enclosed to form a connection slot, a side of the enclosed wall is provided with an opening, and the connection wire is sequentially passed through the connection hole and the opening, and inserted into the connection slot to be connected to the circuit board.

9. The temperature acquisition assembly for the battery cells according to claim 8, wherein the connection slot is filled with a connection glue.

10. The temperature acquisition assembly for the battery cells according to claim 6, comprising voltage acquisition sheets, wherein the voltage acquisition sheets each comprises a first sheet and a second sheet disposed at an included angle, the first sheet is connected to a corresponding one of the busbars, and the second sheet is connected to the circuit board.

11. The temperature acquisition assembly for the battery cells according to claim 1, wherein each of the one or more temperature sensors is snapped into a corresponding one of the one or more accommodation grooves, and a width of an opening of the accommodation groove is smaller than a size of the temperature sensor.

12. The temperature acquisition assembly for the battery cells according to claim 1, wherein the side plates comprise two side plates, the two side plates are respectively located on two sides of the bracket body, and the two side plates are each provided with the one or more accommodation grooves.

13. The temperature acquisition assembly for the battery cells according to claim 1, wherein the one or more accommodation grooves comprise a plurality of the one or more-accommodation grooves, the plurality of accommodation grooves are provided at intervals along an arrangement direction of the battery cells, and each of the accommodation grooves is provided with a corresponding one of the one or more temperature sensors.

14. The temperature acquisition assembly for the battery cells according to claim 1, wherein the bracket body comprises a first side surface and a second side surface that are oppositely disposed, the first side surface is recessedly provided with first positioning grooves, end portions of the battery cells are inserted into the first positioning grooves, the second side surface is recessedly with second positioning grooves, and the second positioning grooves are provided with the busbars.

15. A battery module comprising battery cells and a temperature acquisition assembly for the battery cells comprising a support and one or more temperature sensors, wherein the support comprises side plates and a bracket body that are connected at an included angle, the bracket body is configured to support busbars, the side plates are located at sides of the battery cells, a side surface of each of the side plates which is adjacent to the battery cells is provided with one or more accommodation grooves, openings of the one or more accommodation grooves face towards the battery cells, and the one or more temperature sensors are provided in the one or more accommodation grooves, wherein the one or more temperature sensor of the temperature acquisition assembly for the battery cells are configured to acquire temperatures of the battery cells.

16. The battery module according to claim 15, wherein the side surface of the side plate which is adjacent to the battery cells is protrudingly provided with one or more bosses, and the one or more accommodation grooves are provided in the one or more bosses.

17. The battery module according to claim 16, wherein each of the one or more bosses has an arc surface, the arc surface is fitted with a side surface of a corresponding one of the battery cells, and the accommodation groove is provided on the arc surface.

18. The battery module according to claim 16, wherein each of the one or more bosses is arranged to locate in a free region between adjacent two of the battery cells, when shapes of the battery cells are cylinder-shaped.

19. The battery module according to claim 15, wherein each of the one or more accommodation grooves is filled with a thermally conductive adhesive layer, and a corresponding one of the one or more temperature sensors is located within the thermally conductive adhesive layer.

20. The battery module according to claim 15, wherein the temperature acquisition assembly for the battery cells comprises connection wires, wherein a circuit board is provided at one side of the side plate which is away from the battery cells, a connection hole is provided in each of the one or more accommodation grooves, a first end of each of the connection wires is connected to a corresponding one of the one or more temperature sensors, and a second end of the connection wire is connected to the circuit board by passing through the connection hole.
